(19) United States
(12) Patent Application Publication
(10) Pub. No.: US 2007/0119456 A1
(43) Pub. Date: May 31, 2007

(54) Hypoxic gas stream system and method of use

(76) Inventors: Mark Hollis Scott, San Diego, CA (US); Brian Kenneth Sward, San Diego, CA (US); David Phillip Winter, Encinitas, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/289,056

(22) Filed: Nov. 29, 2005

(51) Int. Cl. A62B 23/02

(52) U.S. Cl. 128/205.27

(57) ABSTRACT

A method of supplying hypoxic gas includes supplying a hypoxic gas with a hypoxic gas supply at a continuous flow rate; and delivering the hypoxic gas intermittently with a conserving mechanism so that an effective hypoxic gas flow rate at least twice the flow rate from the hypoxic gas supply is realized.

### FIELD OF THE INVENTION

The field of this invention relates to hypoxic gas stream systems and methods.

### BACKGROUND OF THE INVENTION

When a person is exposed to a higher altitude or reduced oxygen environment for longer periods, the person acclimatizes to the higher altitude or reduced oxygen environment. The physiological effects of altitude acclimatization produce an increase in the oxygen carrying capacity of the blood and the body's ability to use the oxygen transported resulting in a major difference in the body's ability to perform work both at altitude and at sea level. The net result of such changes is an improvement in athletic performance.

There have been various attempts at providing systems for simulating a different altitude from the altitude that a person resides in order to presumably address the debilitating effects of increased altitude, and/or to obtain some of the advantages of purposely simulating different altitudes for, e.g., athletic training or treatment of a medical condition.

For example, hypoxic rooms or tents have been provided at low altitudes to provide benefits, e.g., the training of athletes, the treating or preventing of altitude sickness as well as other altitude or altitude change related conditions or for the purposes of inducing weight loss. In such systems, a hypoxic gas stream including an oxygen concentration less than atmospheric air is provided to a person in the hypoxic room or tent. As a result, the person is exposed to an atmosphere that simulates an altitude different than the altitude that a person resides in order to obtain some advantage or address some potential problem related to a change in altitude.

A problem recognized by the inventor for hypoxic room or tent systems is that they use a continuous flow of hypoxic gas. As a result the hypoxic gas stream supply is large and heavy, making it difficult and cumbersome for portable and widespread use. The inventor has recognized that by combining a conserving mechanism with an efficient hypoxic gas stream supply the advantages of hypoxic gas use can be more readily achieved by more individuals.

### SUMMARY OF THE INVENTION

To solve these problems and others, an aspect of present invention relates to use of a conserving system for hypoxic gas streams. A conserving system multiplies the apparent gas flow from the hypoxic gas stream source by delivering the hypoxic gas in intervals. The conserving system detects the onset of inhalation and delivers the hypoxic gas when a triggering condition is met. By delivering a flow of gas to the user only during the time when it is useful, i.e., during or near the time the user is inhaling, the apparent flow of hypoxic gas mixtures can be multiplied. This enables the use of a smaller hypoxic gas system.

Another aspect of the invention involves a method of supplying hypoxic gas. The method includes supplying a hypoxic gas with a hypoxic gas supply at a continuous flow rate; and delivering the hypoxic gas intermittently with a conserving mechanism so that an effective hypoxic gas flow rate at least twice the flow rate from the hypoxic gas supply is realized.

Further implementations of the aspect of the invention described immediately above include one or more of the following: The hypoxic gas supply is a hypoxic separator. The hypoxic gas supply is a pressure swing adsorption (“PSA”) system, and supplying includes supplying purged hypoxic gas from the PSA system to the conserving mechanism. The hypoxic gas supply is a vacuum pressure swing adsorption (“VPSA”) system, and supplying includes transferring purged hypoxic gas from the VPSA system to the conserving mechanism under vacuum pressure. The hypoxic gas supply is a ceramic hypoxic gas source. The hypoxic gas supply is a membrane hypoxic gas source. The hypoxic gas supply is a container of compressed hypoxic gas. The conserving mechanism includes a booster compressor and a storage tank, and the method further includes increasing the pressure of the hypoxic gas with the booster, and storing the hypoxic gas in the storage tank for intermittent use of hypoxic gas. The conserving mechanism includes a blower. The conserving mechanism includes an accumulator. The conserving mechanism includes a conserving mask. The conserving mechanism includes a mask. The conserving mechanism includes a cannula. The conserving mechanism provides pulse flow. The conserving mechanism provides demand flow. The conserving mechanism includes means for detecting the inhalation of the user. The means for detecting inhalation is an electronic pressure sensor. The means for detecting inhalation is a mechanical pressure sensor. Delivering includes delivering the hypoxic gas intermittently with a conserving mechanism so that an effective hypoxic gas flow rate at least two times the flow rate from the hypoxic gas supply is realized. The hypoxic gas supply supplies hypoxic gas at less than 15% oxygen by volume. The hypoxic gas supply supplies hypoxic gas at less than 13% oxygen by volume. The hypoxic gas supply supplies hypoxic gas at less than 11% oxygen by volume.

Further objects and advantages will be apparent to those skilled in the art after a review of the drawings and the detailed description of the preferred embodiments set forth below.

### BRIEF DESCRIPTION OF THE DRAWINGS

FIG. 1 is a simple schematic of an embodiment of a hypoxic gas stream conserving system.

FIG. 2 is a simple schematic of another embodiment of a hypoxic gas stream conserving system.

FIG. 3 is a simple schematic of an additional embodiment of a hypoxic gas stream conserving system.

FIG. 4 is a simple schematic of further embodiment of a hypoxic gas stream conserving system.

FIG. 5 is a simple schematic of a still further embodiment of a hypoxic gas stream conserving system.

FIG. 6 is a simple schematic of another embodiment of a hypoxic gas stream conserving system.

FIG. 7 is graph of pressure versus time of a breathing cycle of a user of a hypoxic gas stream conserving system, and shows various conditions or trigger points for triggering the delivery of a pulse of oxygen.

### DETAILED DESCRIPTION OF PREFERRED EMBODIMENTS

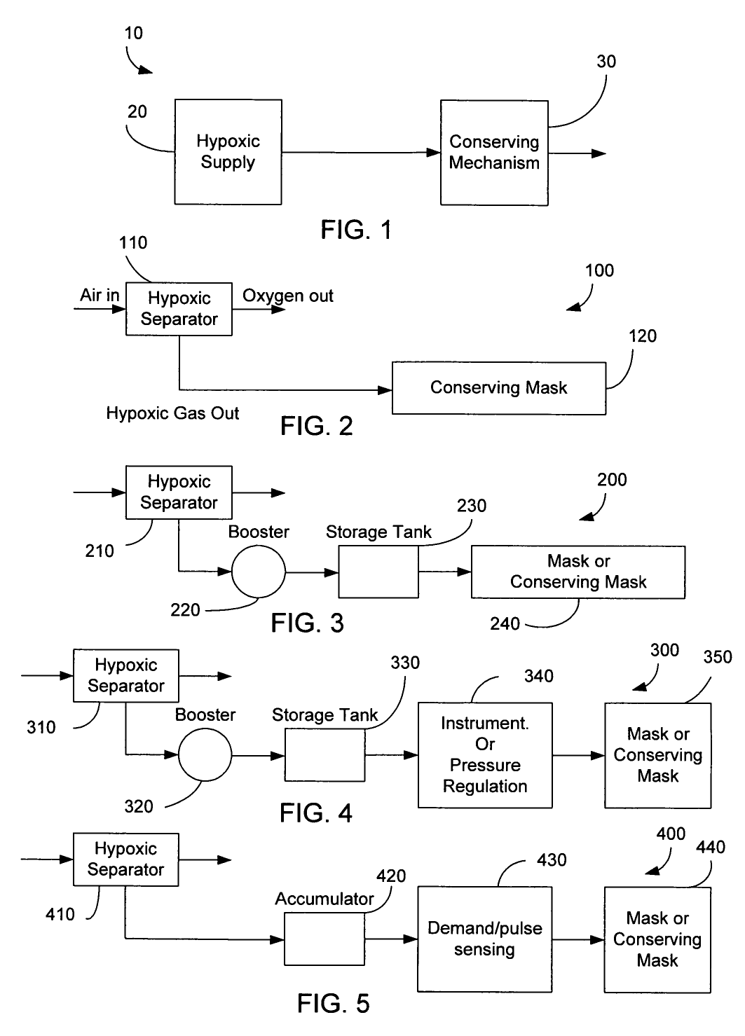

With reference to FIG. 1, an embodiment of a hypoxic gas stream conserving system 10 will be described. The hypoxic gas stream conserving system (“system”) 10 includes a hypoxic gas supply 20 coupled with a conserving mechanism 30.

The hypoxic gas supply 20 supplies a continuous hypoxic gas stream to the conserving mechanism 30. As used herein, a hypoxic gas or gas stream, is gas having an oxygen concentration less than ambient air. The hypoxic gas supply 20 may be one or more of, but not by way of limitation, a hypoxic separator, a concentrator, an oxygen concentrator, a pressure swing adsorption (“PSA”) system, a vacuum pressure swing adsorption (“VPSA”) system, a ceramic hypoxic gas source, a membrane hypoxic gas source, and a container of compressed hypoxic gas. For example, in an embodiment of the system 10 where the hypoxic gas supply 20 is a PSA system, ambient air may be drawn into a compressor and delivered under high pressure to a PSA module. The PSA module separates oxygen from the air, and produces concentrated oxygen as a product gas. Purging of the beds in the PSA module causes a hypoxic gas to be exhausted from the PSA module. This exhausted hypoxic gas is supplied to the conserving mechanism 30, and delivered to the user or application. In an embodiment of the invention, the PSA module is a rotary valve PSA system or rotary valve VPSA system. Example rotary valve PSA and VPSA systems are shown and described in one or more of U.S. Pat. Nos. 6,651,658; 6,691,702; 6,629,525; 5,114,441; 6,311,719; 6,712,087; 6,457,485; 6,471,744; 5,366,541; Re. 35,099; 5,268,021; 5,593,478; 5,730,778, which are incorporated by reference as though set forth in full.

The inventor has determined the following: Newer technologies are leading to higher recovery oxygen concentrators. Similarly, other parallel non-PSA/VPSA techniques such as membrane or ceramics have the advantage of possible less air into a separating process for a corresponding oxygen product. As a result, there is a lower flow rate in the hypoxic purge/exhaust in the newer oxygen separator technologies. The lower flow rate of hypoxic gas creates problems for free-flow hypoxic applications, but the decreased oxygen concentrations resulting from the newer, higher recovery oxygen concentrators improves the hypoxic qualities of the gas stream.

In an embodiment of the invention, the hypoxic gas supply 20 supplies hypoxic gas at less than 11% oxygen by volume. In another embodiment of the invention, the hypoxic gas supply 20 supplies hypoxic gas at 11-13% oxygen by volume. In a further embodiment of the invention, the hypoxic gas supply 20 supplies hypoxic gas at 13-15% oxygen by volume.

Hypoxic gas supplies 20 delivering hypoxic gas in these ranges have relatively low flow rates (e.g., in the low tens of liters per minute). The present inventor has recognized that combining a conserving mechanism 30 with such low flow rate, high recovery oxygen concentrators multiplies the effective flow at least two times, for breathing, and more for other intermittent applications. Combining the conserving mechanism 30 with the low flow rate, high recovery oxygen concentrators is especially helpful for traveling athletes with portable concentrators and other intermittent demand applications for which size, power consumption, noise, weight, and/or portability are important.

The conserving mechanism 30 supplies hypoxic gas flow to the hypoxic application (e.g., hypoxic training tent) or user (e.g. via mask) intermittently, when the application/user needs hypoxic gas, for example, during inhalation. During exhalation, or when there is little or no gas movement, the exhaust gas is stored for delivery during the next demand period. The conserving mechanism 30 may include one or more of, but not by way of limitation, a booster compressor, a blower, a storage tank, a mask, a cannula, pulse flow, demand flow, and a conserving mask. In the embodiment of the system 10 where the hypoxic gas supply 20 is a PSA system, it is important not to obstruct the exhaust/purge. This is the way the PSA system regenerates and renders the process reversible. According, in this embodiment of the system 10, purge is not limited and gas is stored for intermittent flow. For example, exhaust/purge gas may pass into a booster pump, then into a storage tank, then be delivered either in demand or in pulse flow. Example conserving mechanisms, which are for smaller flow rates, high-purity oxygen, and not for hypoxic applications, are described in U.S. Pat. Nos. 6,651,658; 6,691,702; and 6,629,525, which are incorporated by reference as though set forth in full.

With reference to FIG. 2, another embodiment of a hypoxic gas stream conserving system 100 will be described. The system 100 includes a hypoxic separator 110 (e.g., PSA system, VPSA system) as a hypoxic supply and a conserving mask 120 as a conserving mechanism. Ambient air is received by the hypoxic separator 110. A concentrated oxygen gas stream is produced as a product gas and a hypoxic gas stream is produced as an exhaust/purge gas. The hypoxic gas stream is supplied to the conserving mask 120, where hypoxic gas is supplied to the user during inhalation, but not during exhalation.

With reference to FIG. 3, an additional embodiment of a hypoxic gas stream conserving system 200 will be described. The system 200 includes a hypoxic separator 210 as a hypoxic supply and a booster 220, a storage tank 230, and a mask or conserving mask 240 as a conserving mechanism. The hypoxic separator 210 produces a hypoxic exhaust/purge gas stream. The booster 220 supplies the hypoxic gas stream to the storage tank 230 at an elevated pressure. With the booster 220 and storage tank 230, purge is not limited and gas is stored for intermittent flow. The hypoxic gas stream is supplied by the storage tank 230 to the conserving mask 240, where hypoxic gas is delivered in demand mode to the user during inhalation, but not during exhalation. The conserving system 200 multiplies the apparent flow of hypoxic gas to the user compared to free flow.

With reference to FIG. 4, a further embodiment of a hypoxic gas stream conserving system 300 will be described. The system 300 includes a hypoxic separator 310 as a hypoxic supply and a booster 320, a storage tank 330, a pressure regulator or instrument 340, and a mask or conserving mask 350 as a conserving mechanism. The hypoxic separator 310 produces a hypoxic exhaust/purge gas stream. The booster 320 supplies the hypoxic gas stream to the storage tank 330 at an elevated pressure. The regulator 340 drops the pressure of the hypoxic gas from the storage tank 330 to a usable level, and the hypoxic gas stream is supplied to the conserving mask 350, where hypoxic gas is delivered in demand mode to the user during inhalation, but not during exhalation.

With reference to FIG. 5, a still further embodiment of a hypoxic gas stream conserving system 400 will be described. The system 400 includes a hypoxic separator 410 as a hypoxic supply and an accumulator 420, demand/pulse sensor 430, and a mask or conserving mask 440 as a conserving mechanism. The hypoxic separator 410 produces a hypoxic exhaust/purge gas stream that may temporarily be stored in the accumulator 420. With the demand/pulse sensor 430 and mask/conserving mask 440, hypoxic gas is delivered in demand or pulse flow. In an implementation of the system 400, the hypoxic separator 410 may be a VPSA system, where a vacuum mechanism is used to vacuum purge gas off a vent. During the vacuum process, the hypoxic gas is stepped up in pressure above ambient and goes into the accumulator 420. Thus, with the VPSA system, a booster is not required.

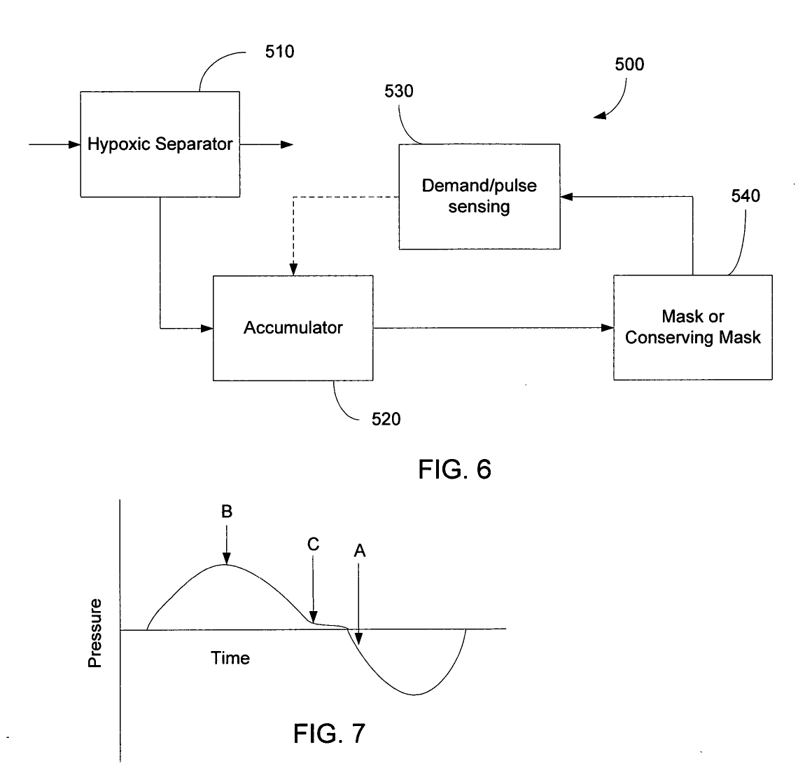

With further reference to FIG. 6, another embodiment of a hypoxic gas stream conserving system 500 will be described. The system 500 includes a hypoxic separator 510 as a hypoxic supply and an accumulator 520, demand/pulse sensor 530, and a mask or conserving mask 540 as a conserving mechanism. The hypoxic separator 510 produces a hypoxic exhaust/purge gas stream that may temporarily be stored in the accumulator 520. The demand/pulse sensor 530 is a mechanical pressure sensor or an electronic pressure sensor. In an implementation of this embodiment, the mask or conserving mask 540 is connected to the demand/pulse sensor 530 by a length of tubing other than the length of tubing used for delivering hypoxic gas from the conserving mechanism to the user. Such an independent connection reduces the pressure transients experienced by the demand/pulse sensor 530 during the delivery of a pulse of hypoxic gas.

With reference to FIG. 7, in alternative embodiments, various conditions or trigger points are used to trigger the delivery of a pulse of oxygen. For example, in one embodiment, the demand/pulse sensor 530 detects a start of inhalation condition (See point A) by the user. In another embodiment, the demand/pulse sensor 530 detects a peak of exhalation condition (See point B) by the user. In a further embodiment, the demand/pulse sensor 530 detects a decay of exhalation condition (See point C) by the user.

As the gas volumes required for hypoxic demand/pulse operation are quite high, in further embodiments, various means are used to reduce the disturbance caused by the high rate of flow of hypoxic gas delivered to the user. For example, but not by way of limitation, a large flow of gas can be initiated without the disturbance of a square wave pulse by ramping flow rate of the hypoxic gas flow.

With the hypoxic gas stream conserving systems and methods described above, hypoxic gas is supplied in an efficient manner by the hypoxic gas supply 20 and the hypoxic gas is consumed in an efficient manner with the conserving mechanism 30. The apparent gas flow is multiplied from the hypoxic gas stream source by delivering the hypoxic gas intermittently or in intervals. Using demand flow or pulse flow, gas storage, and/or pressure boosting, the apparent flow of hypoxic gas mixtures can be multiplied also. Combining the conserving mechanism with the higher recovery hypoxic separator multiplies the effective flow at least two times, for breathing, and more for other intermittent applications. Combining the conserving mechanism with the higher recovery hypoxic separator is especially helpful for traveling athletes with portable concentrators and other intermittent demand applications for which size, power consumption, noise, weight, and/or portability are important.

It will be readily apparent to those skilled in the art that still further changes and modifications in the actual concepts described herein can readily be made without departing from the spirit and scope of the invention as defined by the following claims.

We claim:

1. A method of supplying hypoxic gas, comprising:
supplying a hypoxic gas with a hypoxic gas supply at a continuous flow rate; and
delivering the hypoxic gas intermittently with a conserving mechanism so that an effective hypoxic gas flow rate at least twice the flow rate from the hypoxic gas supply is realized.

2. The method of claim 1, wherein the hypoxic gas supply is a hypoxic separator.

3. The method of claim 1, wherein the hypoxic gas supply is a pressure swing adsorption (“PSA”) system, and supplying includes supplying purged hypoxic gas from the PSA system to the conserving mechanism.

4. The method of claim 1, wherein the hypoxic gas supply is a vacuum pressure swing adsorption (“VPSA”) system, and supplying includes transferring purged hypoxic gas from the VPSA system to the conserving mechanism under vacuum pressure.

5. The method of claim 1, wherein the hypoxic gas supply is a ceramic hypoxic gas source.

6. The method of claim 1, wherein the hypoxic gas supply is a membrane hypoxic gas source.

7. The method of claim 1, wherein the hypoxic gas supply is a container of compressed hypoxic gas.

8. The method of claim 1, wherein the conserving mechanism includes a booster compressor and a storage tank, and the method further includes increasing the pressure of the hypoxic gas with the booster, and storing the hypoxic gas in the storage tank for intermittent use of hypoxic gas.

9. The method of claim 1, wherein the conserving mechanism includes a blower.

10. The method of claim 1, wherein the conserving mechanism includes an accumulator.

11. The method of claim 10, wherein the hypoxic gas supply is a vacuum pressure swing adsorption (“VPSA”) system, and supplying includes transferring purged hypoxic gas from the VPSA system to the accumulator under vacuum pressure.

12. The method of claim 1, wherein the conserving mechanism includes a conserving mask.

13. The method of claim 1, wherein the conserving mechanism includes a mask.

14. The method of claim 1, wherein the conserving mechanism includes a cannula.

15. The method of claim 1, wherein the conserving mechanism provides pulse flow.

16. The method of claim 1, wherein the conserving mechanism provides demand flow.

17. The method of claim 1, wherein the hypoxic gas supply is a rotary valve pressure swing adsorption (“PSA”) system, and supplying includes supplying purged hypoxic gas from the rotary valve PSA system to the conserving mechanism.

18. The method of claim 1, wherein the hypoxic gas supply supplies hypoxic gas at less than 15% oxygen by volume.

19. The method of claim 1, wherein the hypoxic gas supply supplies hypoxic gas at less than 13% oxygen by volume.

20. The method of claim 1, wherein the hypoxic gas supply supplies hypoxic gas at less than 11% oxygen by volume.

21. The method of claim 1, wherein the conserving mechanism includes at least one of a demand sensor and a pulse sensor.

22. The method of claim 21, wherein the sensor is at least one of a mechanical pressure sensor and an electronic pressure sensor.

23. The method of claim 21, further including a line for delivering hypoxic gas from the conserving mechanism to a user and a separate line, other than the line for delivering hypoxic gas from the conserving mechanism to the user, connecting the sensor to the conserving mechanism to reduce pressure transients experienced by the sensor during delivery of a pulse of hypoxic gas.

24. The method of claim 21, wherein a pulse of oxygen is delivered when the sensor detects the start of inhalation by a user.

25. The method of claim 21, wherein a pulse of oxygen is delivered when the sensor detects a peak of exhalation by a user.

26. The method of claim 21, wherein a pulse of oxygen is delivered when the sensor detects a decay of exhalation by a user.

27. The method of claim 1, wherein hypoxic gas flow is delivered to a user in a ramped-up fashion.
